(19) United States
(12) Patent Application Publication
(10) Pub. No.: US 2005/0046158 A1
(43) Pub. Date: Mar. 3, 2005

(54) Leg protection device

(75) Inventor: Kazuhiro Abe, Echi-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/820,015

(22) Filed: Apr. 8, 2004

(30) Foreign Application Priority Data
Aug. 26, 2003 (JP) 2003-301608

(51) Int. Cl. B60R 21/22

(52) U.S. Cl. 280/730.1

(57) ABSTRACT

A leg protection device including an airbag arranged inside a member disposed in front of a seat. The device includes a gas generator for inflating the airbag; and a cover covering the airbag and configured to open when the airbag is inflated. The cover is configured to break along tear lines when the airbag is inflated to form a plurality of laterally arranged flaps when the airbag is inflated.

### BACKGROUND

The present invention relates to a leg protection device for protecting the lower legs of an occupant sitting in a vehicle seat. The device is configured to prevent the legs from impacting an interior panel located in front of the seat.

An occupant-leg protection device for protecting lower legs of an occupant from hitting against an interior panel in front of a seat in a collision of a high-speed moving object such as a vehicle normally includes an airbag disposed inside the interior panel (a space on the reverse side of the interior panel), a gas generator for inflating the airbag, and a cover for covering the airbag during normal operation (i.e., when the high-speed moving object such as the vehicle does not encounter a collision).

In such an occupant-leg protection device, during normal operation of the vehicle, the airbag is arranged inside the interior panel in a folded state, and the cover is attached so as to cover the folded airbag therewith.

When a collision occurs, the gas generator is operated to supply gas to the airbag so that the airbag is rapidly inflated. Inflation of the airbag causes the cover to open to allow the airbag to expand outside the interior panel and to inflate and develop between the interior panel and occupant lower legs for protecting the occupant lower legs from hitting against the interior panel.

Japanese Unexamined Patent Application Publication No. 2003-40069 discloses that the cover is provided with tear lines so that a predetermined section will partially separate from remainder of the cover allowing the airbag to deploy. The tear lines are U-shaped and extending along lateral edges and the upper edge of the cover. The predetermined section or flap is attached to the cover by a hinge extending along the lower edge of the cover. When the airbag is inflated, the cover breaks along the tear lines and the flap rotates downward and about the hinge as a rotation axis. As a result, the airbag deploys to a position in front of the occupant lower legs.

In the occupant-leg protection device according to Japanese Unexamined Patent Application Publication No. 2003-40069 (incorporated by reference herein), since the flap is large, the momentum of the flap is large during the rotation. Therefore, when the rotating flap comes in contact with an occupant leg, the impact is rather large.

### SUMMARY OF THE INVENTION

An object of the present invention is to provide an occupant-leg protection device with small impact produced when a rotating flap comes in contact with an occupant leg.

According to an embodiment of the present invention a leg protection device is provided. The device includes an airbag arranged inside a member disposed in front of a seat; a gas generator for inflating the airbag; and a cover covering the airbag so as to open when the airbag is inflated. The cover includes break-predestined sections or tear lines that are positioned to allow the cover to form a plurality of flaps when the airbag is inflated. The tear lines or break-predestined section a positioned to form a plurality of the laterally arranged flaps.

According to an embodiment of the present invention, the break-predestined section may preferably form four or more laterally arranged flaps.

According to an embodiment of the present invention, the break-predestined section may form a flap to be upward opened and a flap to be downward opened.

According to the occupant-leg protection device of the present invention, a plurality of laterally arranged flaps are formed when an airbag is inflated. As a result, the weight of each flap is relatively small. Thus, the kinetic momentum produced be each flap is small so that the impact applied to a leg of an occupant becomes small when the rotating flap contacts the leg.

If four or more flaps are laterally formed, this impact is further reduced. Also, when a flap to be upward opened and a flap to be downward opened are formed, the impact is further reduced.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a longitudinal sectional view of a leg protection device according to an embodiment of the present invention.

FIG. 2 is a plan view of the reverse surface of an interior panel showing a cover section.

FIG. 3 is a perspective view showing the interior panel when the cover section starts opening.

FIG. 4 is a plan view of the reverse surface of the interior panel showing another example of the cover section.

FIG. 5 is a plan view of the reverse surface of the interior panel showing still another example of the cover section.

FIG. 6 is a plan view of the reverse surface of the interior panel showing further another example of the cover section.

### DETAILED DESCRIPTION

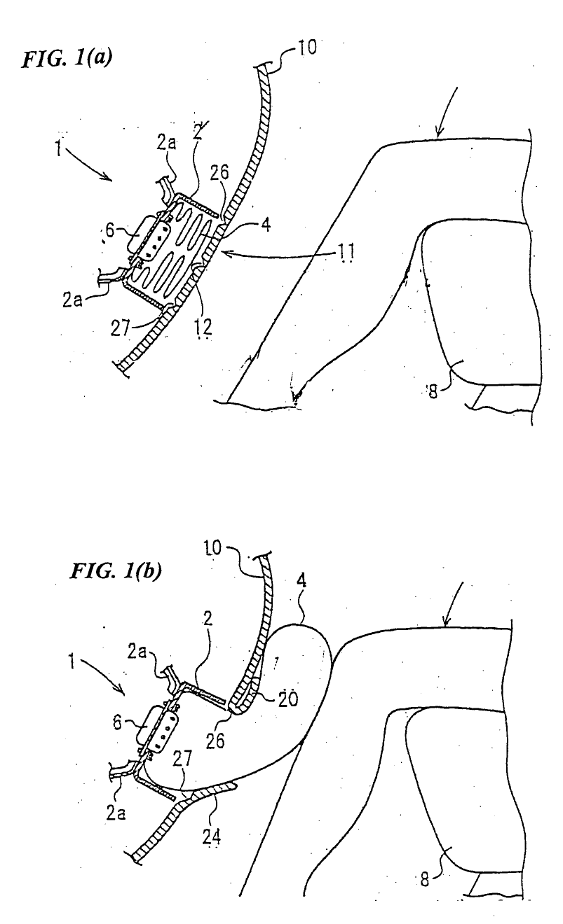

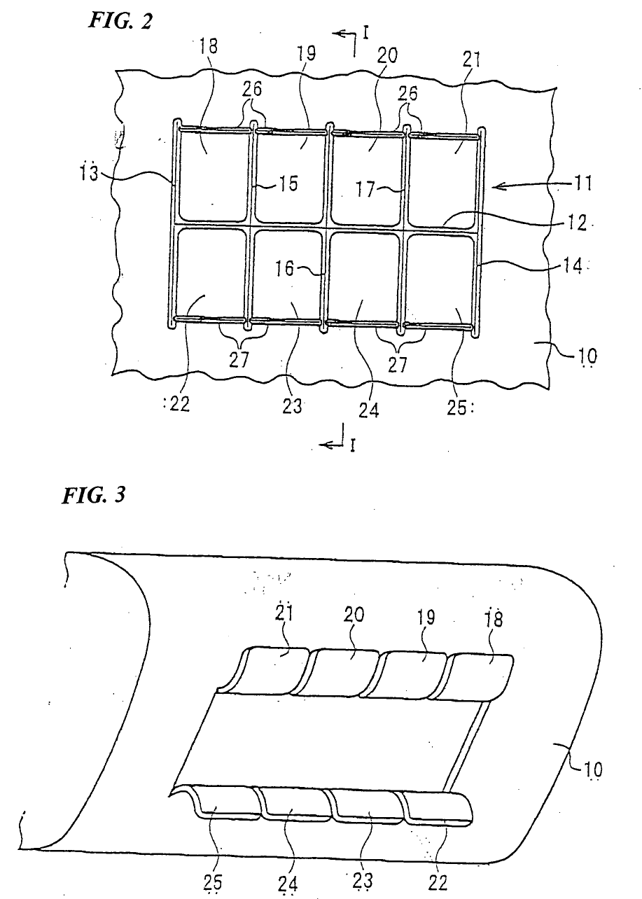

An embodiment according to the present invention will be described below with reference to the drawings. FIG. 1 is a longitudinal sectional view (sectional view at the line I-I of FIG. 2) of an occupant-leg protection device according to an embodiment of the present invention; FIG. 1(a) shows a non-inflation state of an airbag; and FIG. 1(b) shows an inflated state of the airbag. FIG. 2 is a plan view of the reverse side of an interior panel in a cover section; and FIG. 3 is a perspective view of the interior panel when the cover section starts opening.

As shown in FIG. 1, a leg protection device 1 according to an embodiment of the present invention, includes a container-like retainer 2 having an opening formed on the front surface (surface adjacent to an occupant), an airbag 4 arranged and folded inside the retainer 2, and a gas generator 6 for inflating the airbag 4. The retainer 2 is covered by a portion of an interior panel 10.

The retainer 2 may be connected to the vehicle body (not shown) via a bracket 2a. The interior panel 10 includes a cover section 11 covering the front opening of the retainer 2. The cover section 11 opens when the airbag 4 inflates.

The cover section 11 is designed to break or separate along predetermined tear lines. As shown in FIG. 2, the cover section 11 includes a center tear line 12 formed in the vicinity of the vertical intermediate position of the cover section 11 and extending in the lateral direction (vehicle width direction), first and second vertical tear lines 13 and 14 extending in the vertical direction respectively along left and right sides of the cover section 11, and third, fourth, and fifth vertical tear lines 15, 16, and 17 extending in the vertical direction in parallel with each other between the first and second vertical tear lines 13 and 14. The first and second vertical tear lines 13 and 14 are connected to left and right ends of the center tear line 12 in the vicinities of the intermediate positions thereof, respectively. The vicinities of the intermediate positions of the third to fifth vertical tear lines 15 to 17 intersect at positions in the halfway of the center tear line 12, respectively.

The tear lines 12 to 17 are preferably formed as concave grooves on the reverse (i.e., back) surface of the cover section 11, and are fragile sections with a small panel thickness along therewith. Therefore, when the airbag 4 is inflated, the cover section 11 breaks along the tear lines 12 to 17 due to a pressure force from the airbag 4 so as to open toward an occupant in flap shapes.

According to the embodiment of the present invention shown in FIG. 2, the cover section 11 is divided into zones by the tear lines 12 to 17. The divided cover section 11 includes four above regions and four below regions, eight regions in total. Therefore, when the cover section 11 breaks along the tear lines 12 to 17 during the inflation of the airbag, eight flaps 18, 19, 20, 21, 22, 23, 24, and 25 are formed.

According to the an embodiment of the present invention, each of the flaps 18 to 25 is provided with a hinge (bending induction part) 26 or 27 formed on the base. The hinges 26 and 27 are preferably formed as linear fragile concave grooves, with a depth smaller than those of the tear lines 12 to 17. The hinges extend in the horizontal direction so as to respectively connect the upper ends and the lower ends of the vertical tear lines 13 to 17 together. The flaps 18 to 25 are forced by the airbag 4 inflating toward the surface of the interior panel 10 so as to open toward an occupant by bending from the hinges on the bases. The flaps 18, 19, 20, and 21 are rotate upward about the upper hinge 26 as a rotation axis while the flaps 22, 23, 24, and 25 are rotate downward about the lower hinge 27 as a rotation axis.

According to the embodiment of the present invention, in a vehicle collision, the gas generator 6 is operated to inject gas which in turn starts inflating the airbag 4 so as to open the cover section 1 of the interior panel 10 for pushing the inflating airbag 4 outside the surface of the interior panel 10. Then, as shown in FIG. 1(b), the inflated airbag 4 receives occupant legs so as to prevent the occupant legs from hitting against the interior panel 10.

As shown in FIG. 3, the cover section 11 is separated into eight flaps by the inflating airbag 4. Four flaps 18 to 21 open upward from the vicinity of the center in the vertical direction, and four flaps 22 to 25 open downward therefrom. Accordingly, each of the flaps 18 to 25 is relatively lightweight in order to reduce the kinetic momentum associated with the flap at the beginning of its movement. Therefore, even in the case where the occupant legs are located extremely close to the interior panel 10 (e.g., when an occupant is seated forward on the front passenger seat 8 or when an occupant is seated on the front passenger seat 8 which is moved toward the vehicle front) the impact applied to the occupant leg is relatively small even when any of the flaps 18 to 25 strikes the occupant leg as the flap swings open.

According to the present invention, the structures, such as the shape of the cover section, the number and shape of the flaps formed by breaking of the cover section during the airbag inflation, and the opening direction, are not limited to the structures shown in FIGS. 1 to 3, and various modifications may be made.

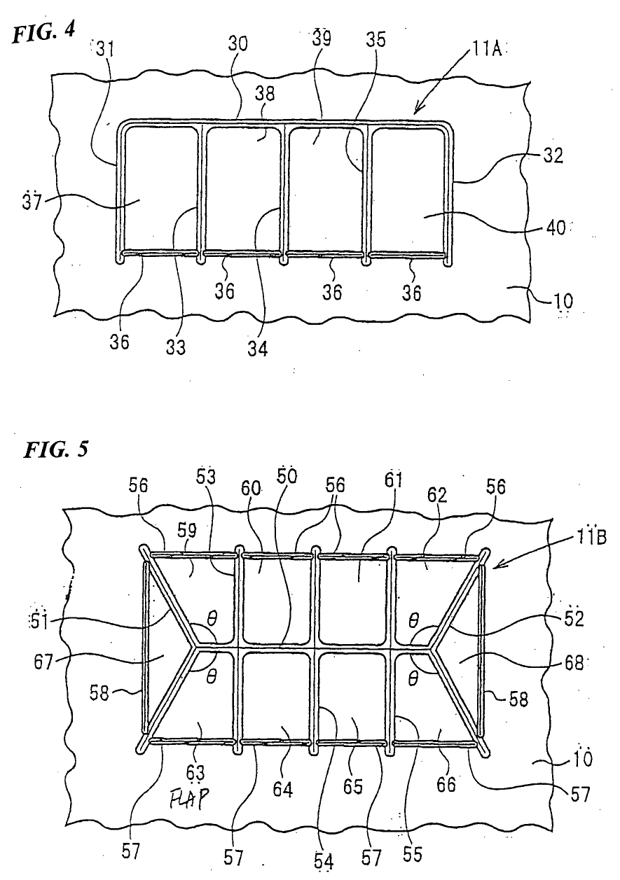

For example, as shown in FIG. 4, a cover section 11A may include a horizontal tear line 30 extending in the lateral direction along the upper side of the cover section 11A, first and second vertical tear lines 31 and 32 extending in the vertical direction respectively along left and right sides of the cover section 11A, and third, fourth, and fifth vertical tear lines 33, 34, and 35 extending in the vertical direction in parallel with each other between the first and second vertical lines 31 and 32. The first and second vertical tear lines 31 and 32 are connected to left and right ends of the horizontal tear line 30 at the upper ends thereof, respectively. The upper ends of the third to fifth vertical tear lines 33 to 35 are connected to the halfway of the horizontal tear line 30. Also, a hinge 36, which is a concave groove shallower than those of these tear lines, extends in the horizontal direction along the lower side of the cover section 11A so as to connect the lower ends of the vertical tear lines 31 to 35 together.

The cover section 11A is divided by the tear lines 30 to 35 and the hinge 36 into four regions. The cover section 11A breaks along these tear lines 30 to 35 by a pressure force from the airbag 4 during the inflation of the airbag 4 (not shown in FIG. 4) to form four flaps 37, 38, 39, and 40. The flaps 37 to 40 open downward by bending from the hinge 36 at the respective lower ends.

According to the embodiment of the present invention shown in FIG. 4, because the cover section 11A is divided into the four flaps 37 to 40, each of the flaps 37 to 40 is relatively light weight thereby reducing the kinetic momentum of the flap while its moving into a fully open position. As a result, the impact applied to the occupant leg is relatively small even when any of the flaps 37 to 40 strikes the occupant leg during opening.

According to an alternative embodiment of the present invention, as shown in FIG. 5, a cover section 11B includes a center tear line 50 formed in the vicinity of the vertical intermediate position of the cover section 11B and extending in the lateral direction, first and second vertical tear lines 51 and 52 extending in the substantially vertical direction respectively on left and right both sides of the center tear line 50, and third, fourth, and fifth vertical tear lines 53, 54, and 55 extending in the vertical direction in parallel with each other between the first and second vertical tear lines 51 and 52. The first and second vertical tear lines 51 and 52 are connected, in the vicinities of the intermediate positions thereof, to the left and right ends of the center tear line 50, respectively. The vicinities of the intermediate positions of the third to fifth vertical tear lines 53 to 55 intersect at positions in the halfway of the center tear line 50, respectively.

According to this structure, in the respective first and second vertical tear lines 51 and 52, the upper half section and the lower half section extend in directions intersecting with the center tear line 50 from the vicinity of each intermediate position, respectively, while any intersecting angle θ of each section with the center tear line 50 is an obtuse angle. The remaining third to fifth vertical tear lines 53 to 55 extend linearly in the vertical direction so as to orthogonally cross the center tear line 50. Alternatively, the third to fifth vertical tear lines 53 to 55 may extend in directions intersecting with the center tear line 50.

In order to connect the upper ends and the lower ends of the vertical tear lines 51 to 55 together, hinges 56 and 57, which are concave grooves shallower than those of these vertical tear lines, are provided to extend in the horizontal direction respectively along the upper and lower sides of the cover section 11B. Also, hinges 58, which are shallow concave grooves identical to those of the hinges 56 and 57, are provided to extend in the vertical direction respectively along the left and right sides of the cover section 11B so as to respectively connect the upper and lower ends of the first vertical tear line 51 together and the upper and lower ends of the second vertical tear line 52 together.

The cover section 11B, as shown in FIG. 5, is divided into ten regions by the tear lines 50 to 55 and the hinges 56 to 58. The cover section 11B breaks along these tear lines 50 to 55 due to the force of the deploying airbag to form ten flaps 59, 60, 61, 62, 63, 64, 65, 66, 67, and 68 in total. The four flaps 59 to 62 open upward by bending from the hinge 56 at the respective upper ends. Four flaps 63 to 66 open downward opened by bending from the hinge 57 at the respective lower ends. Two flaps 67 and 68 open laterally outward by bending from the left and right hinges 58.

As in the previous embodiments discussed above, since the cover section 11B is divided into the ten flaps 59 to 68, the weight of the flaps is reduced. As a result, the kinetic momentum of the flaps during opening is reduced. Therefore, the impact applied to the occupant leg becomes small even when any of the flaps 59 to 68 hits at the occupant leg during opening.

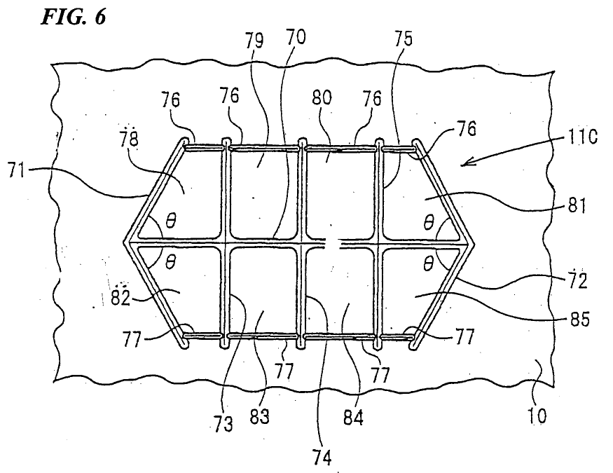

According to an alternative embodiment of the present invention, cover section 11C shown in FIG. 6 includes a center tear line 70 formed in the vicinity of the vertical intermediate position of the cover section 11C and extending in the lateral direction, first and second vertical tear lines 71 and 72 extending in the substantially vertical direction respectively on left and right both ends of the center tear line 70, and third, fourth, and fifth vertical tear lines 73, 74, and 75 extending in the vertical direction in parallel with each other between the first and second vertical tear lines 71 and 72. The first and second vertical tear lines 71 and 72 are connected, in the vicinities of the intermediate positions thereof, to the left and right ends of the center tear line 70, respectively. The vicinities of the intermediate positions of the third to fifth vertical tear lines 73 to 75 intersect at positions in the halfway of the center tear line 70, respectively.

According to this structure, in the respective first and second vertical tear lines 71 and 72, as shown in the drawing, the upper half section and the lower half section extend in directions intersecting with the center tear line 70 from the vicinity of each intermediate position, respectively, while any intersecting angle θ of each section with the center tear line 50 is an acute angle. The remaining third to fifth vertical tear lines 73 to 75 extend linearly in the vertical direction so as to orthogonally cross the center tear line 70. Alternatively, the third to fifth vertical tear lines 73 to 75 may extend in directions intersecting with the center tear line 70.

In order to respectively connect the upper ends and the lower ends of the vertical tear lines 71 to 75 together, hinges 76 and 77, which are concave grooves shallower than those of these vertical tear lines, are provided to extend in the horizontal direction respectively along the upper and lower sides of the cover section 11C.

The cover section 11C, as shown in FIG. 6, is divided into eight regions by the tear lines 70 to 75 and the hinges 76 to 77. Therefore, when the cover section 1 IC breaks along the tear lines 70 to 75 as the airbag deploys, eight flaps 78, 79, 80, 81, 82, 83, 84, and 85 are formed. Four flaps 78 to 81 open upward opened by bending from the hinge 76 at the respective upper ends while four flaps 82 to 85 open downward by bending from the hinge 77 at the respective lower ends.

As in the previous embodiments discussed above, since the cover section 11C is divided into the eight flaps 78 to 85, the weight of the flaps is reduced. As a result, the kinetic momentum of the flaps during opening is reduced. Therefore, the impact applied to the occupant leg becomes small even when any of the flaps 78 to 85 hits at the occupant leg during opening.

Japan Patent Application No. 2003-301608, filed Aug. 26, 2003, is incorporated herein by reference in its entirety.

Given the disclosure of the present invention, one versed in the art would appreciate that there may be other embodiments and modifications within the scope and spirit of the invention. For example, in the above structures, the cover section covering the front opening of the retainer is integrally formed with the interior panel; alternatively, the cover may be provided separately from the interior panel. Accordingly, all modifications attainable by one versed in the art from the present disclosure within the scope and spirit of the present invention are to be included as further embodiments of the present invention. The scope of the present invention is to be defined as set forth in the following claims.

1. A leg protection device comprising:
an airbag arranged inside a member disposed in front of a seat;
a gas generator for inflating the airbag; and
a cover covering the airbag and configured to open when the airbag is inflated,
wherein the cover is configured to break along tear lines when the airbag is inflated to form a plurality of laterally arranged flaps when the airbag is inflated.

2. The device of claim 1, wherein the tear lines are positioned so that at least four laterally arranged flaps are formed.

3. The device of claim 1, wherein the tear lines are positioned so that at least one flap opens upward and at least one flap opens downward.

4. A breakable cover for an airbag configured to deploy into a position for protecting the legs of an occupant of a vehicle seat, wherein the cover comprises a tear line positioned so that when the cover breaks as a result of the inflation of the airbag a first portion of the cover rotates upward and a second portion of the cover rotates downward.

5. The cover of claim 4, wherein the first portion of the cover includes a plurality of flaps.

6. The cover of claim 4, wherein the second portion of the cover includes a plurality of flaps.

7. The cover of claim 4, wherein the tear line is positioned so that when the cover breaks a third portion of the cover rotates laterally.

8. The cover of claim 7, wherein the third portion of the cover includes a plurality of flaps.

9. The cover of claim 4, wherein the tear line includes a plurality of vertical sections.

10. An airbag module for protecting the legs of vehicle occupant comprising an airbag and a frangible cover overlying the airbag, wherein the cover includes a tear line and a hinge portion positioned so that cover breaks a first portion of the cover rotates upward and a second portion of the cover rotates downward.

11. The module of claim 10, wherein the first portion of the cover includes a plurality of flaps.

12. The module of claim 11, wherein the cover includes additional tear lines positioned in the first portion of the cover to form the plurality of flaps.

13. The module of claim 12, wherein the additional tear lines are parallel.

14. The module of claim 10, wherein the cover is configured to break into the first portion, the second portion and a third portion, wherein the third portion is configured to rotate laterally in a direction generally orthogonal to the vertical direction.
